(19) United States
(12) Patent Application Publication
(10) Pub. No.: US 2013/0097509 A1
(43) Pub. Date: Apr. 18, 2013

(54) VIDEO STICKER ALBUM AVAILABLE ON LINE AND SYSTEM DEVELOED FOR OPERATIONALIZING SUCH ALBUM

(71) Applicant: Elton Silva Gomes, Belo horizonte (BR)

(72) Inventor: Elton Silva Gomes, Belo horizonte (BR)

(73) Assignee: ELR SOLUCOES DIGITAIS S/A, Belo horizonte (BR)

(21) Appl. No.: 13/273,044

(22) Filed: Oct. 13, 2011

(51) Int. Cl. G06F 3/01

(52) U.S. Cl. 715/723

(57) ABSTRACT

A video sticker album is available through the a network, such as the Internet, that enables online trading. In such an album, each image is formed by at least one video sticker, which when completed will produce a video of a scene in question, which can be seen as many times as the user/collector so desires. A system provides access and allows users/collectors to acquire credits and obtain images through the video sticker systems such as PoS (point of sale) used by credit card/or debit cards management companies, ePay, e-commerce and/or SMS (cell phones).

### FIELD

This patent application aims to describe a video sticker album available through the Internet that enables online trading. In such album, each image will be formed by at least one video sticker, which when completed will produce a video on the scene in question, that can be seen as many times as the user/collector so desires. The album of the present invention will be made possible by means of a system developed through an understanding of simple software that allows users/collectors to acquire credits through the stickers video systems PoS (point of sale) used by credit card or debit card management companies, ePay, e-commerce and/or SMS (cell phone).

### BACKGROUND

Collectible albums on physical media or over the internet are already known in the state of the art for some time.

Examples of patent documents relating to the topic are: PI0107022-3 filed on Dec. 19, 2001 by Connect Pay TV Businesess Ltda., entitled “Sistema de album via internet”; PI0106490-8 filed on Dec. 5, 2001 by Luiz Felipe Coelho Filizzola, entitled “Sistema para colecionar figurinhas em álbum virtual, utilizando um método fisico de controle e venda”; KR20080006729, entitled “System and method for constituting community using eletronic albums and managing electronic albums”; KR20070080393, entitled “System of scenario álbum using internet”; KR20000054681, entitled “System for supplying moving picture album via the internet”; KR20080049154, entitled “System for supplying moving picture álbum via internet”; and international application WO2008/041044, entitled” System for collecting of album stickers via internet”, internationally filed on behalf of Tomislav KORDA, filed on Oct. 3, 2007.

The collection systems and exchange of cards as a physical media that exist in the prior art and according to the knowledge of the inventor, are based on printed sticker albums, which are sold in kiosks, newsstands, bookshops, internet, etc. In this segment, the world leader in printed albums publishes their own albums using graphics services of the respective countries. This procedure, besides being a limiting trading aspect, generates a huge and expensive monitoring and management structure.

Moreover, it is known that many countries do not publish albums or stickers. The population remains with the option of ordering albums and stickers from other countries through the Internet (for example), but this also presents drawbacks, such as: the fact that they are in other languages; the process becomes expensive; there is a delivery problem; communications are slow; the need of information updates; the market is limited by the “few” points of sale and the fact that the access to credit cards is difficult in most cases (since the target audience in question is formed mostly by minors) when the product is purchased online; not to mention the very charm of the game.

Besides the above mentioned problems, the inventor has identified other problems and deficiencies related to the state of the art, namely: lack of image movement; little encouragement of thinking; and the difficulty of applying product in promotions generating market information.

### BRIEF DESCRIPTION OF THE DRAWINGS

FIG. 1. Shows an example of the page related to the acquisition system of the video stickers (vs) by PoS, wherein: a) shows the mechanical system used in an exemplary video sticker album with respect to the acquisition of video codes for stickers (vs) in PoS system, b) shows the mechanical system used in the video sticker album with respect to the acquisition of video codes for stickers (vs) in e-commerce over the internet, and c) shows the mechanics of the system used in the video sticker album with respect to the acquisition of video codes for stickers (vs) in SMS via mobile phones.

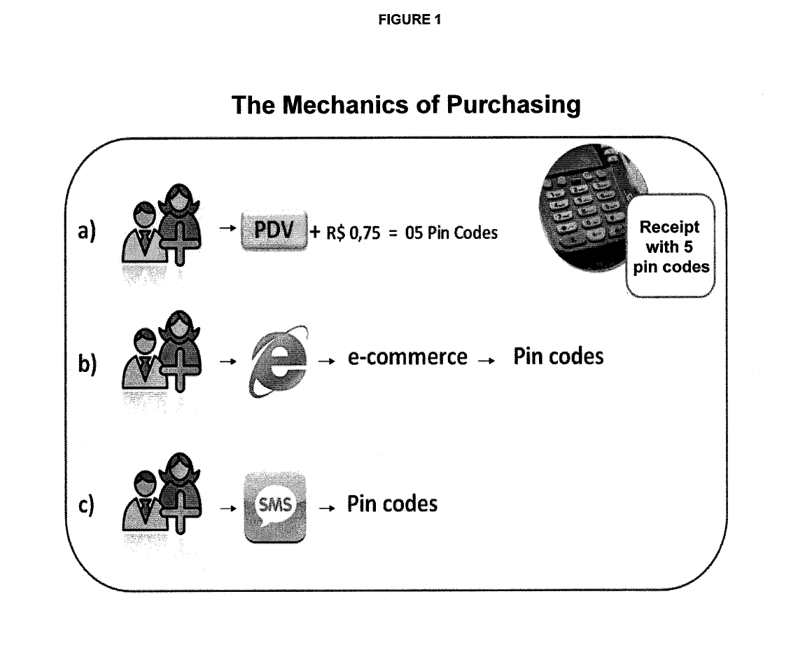

FIG. 1.1. Shows an example of the page related to the acquisition system of the video stickers (vs) by means of promotions, wherein: a) shows the mechanical system used in the video sticker album with respect to the acquisition of video codes for stickers (vs) in bottle caps; b) shows the mechanics used in the video sticker album with respect to the acquisition of video codes of stickers (vs) in can seals.

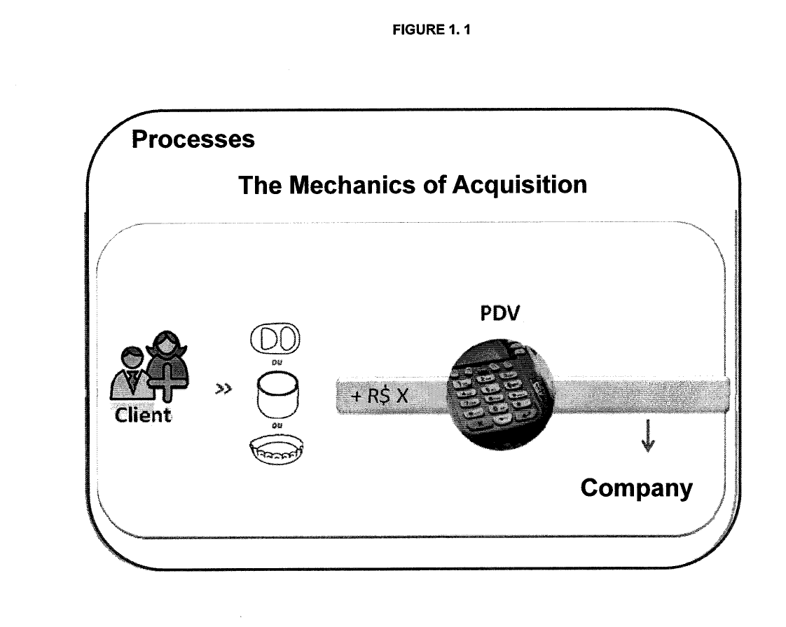

FIG. 2. Shows the layout of an example of the page for access to video sticker album.

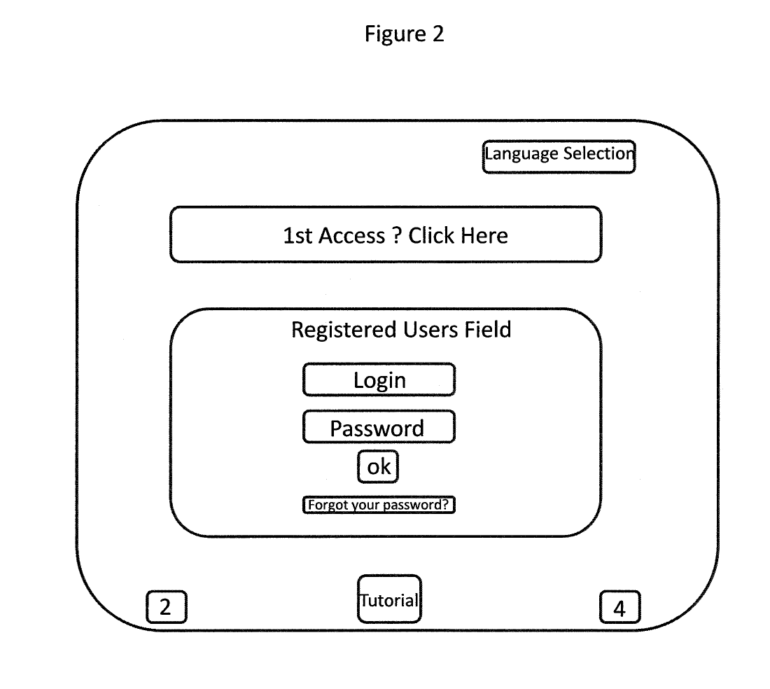

FIG. 3. Shows the layout of an example of the promotion page of the product by means of a quiz system to purchase the video sticker album.

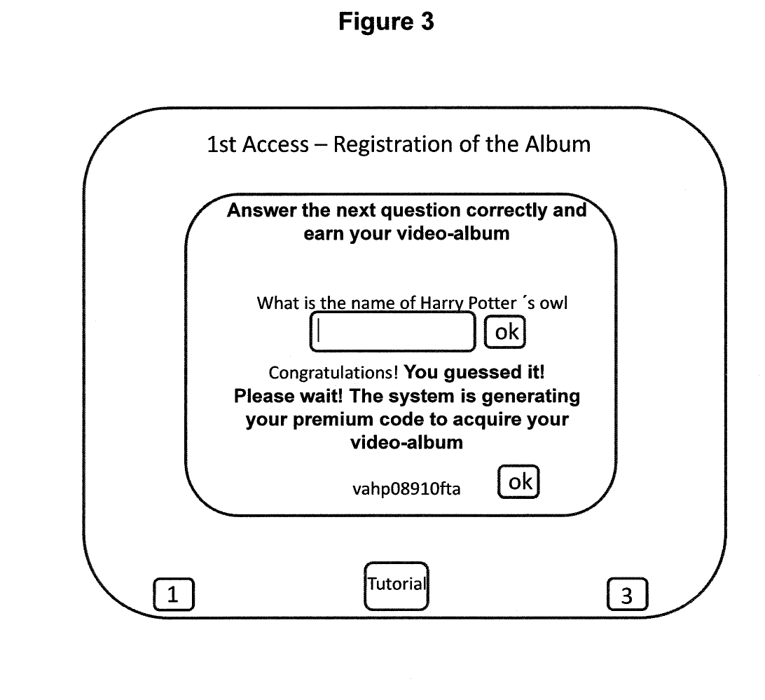

FIG. 4. Shows the layout of an example of terms and conditions page for the user to join as a collector.

FIG. 5. Shows an example of the “front page”, i.e., the video sticker album cover with navigation and access to content buttons.

FIG. 6. Shows the layout of an example of the “buy” page

FIG. 7. Shows the layout of an example of the page used to “download stickers” with the codes acquired by the collector.

FIG. 8. Shows the layout of an example of the video selection page for extra-stickers, which will be enabled only for promotional albums.

FIG. 9. Shows the layout of an example of the selection page and access to video sticker album for the user/collector, called “my album”.

FIG. 10. Shows the layout of an example of the “trading” page for the user/collector.

FIG. 11. Shows the layout of an example of the “multi trade” page for the user/collector.

FIG. 12. Shows the layout of an example of the “quotation” page for the video sticker album on demand by the users/collectors.

FIG. 13. Shows the layout of an example of the “my account” page for the user/collector.

FIG. 14. Shows the layout of an example of the page “my account—my class” that provides information from friends and/or registered user/collector, which corresponds to the field number 4 in FIG. 13.

FIG. 15. Shows the layout of an example of the registration page of the spare video stickers of the user/collector, called “my account—chromes repeated.”

FIG. 16. Shows the layout of an example of the registration page of video stickers desired by the user/collector, called “my account—wanted chromes.”

FIG. 17. Shows the layout of an example of the page “my account—my credits” which shows the amount of video stickers available for stamping as well as the bonuses gained by the user/collector.

FIG. 18. Shows the layout of an example of the page “my account—chrome & gold torpedoes” that controls the amount of special/promotional chromes (premium and gold).

FIG. 19. Shows the layout of an example of the page of the VIP club of friends of the user/collector, called “VIP club”.

FIG. 20. Shows an example of the contact options with management and customer service of the video sticker album, called “contact”.

FIG. 21. Shows an example of the contact options with management and customer service of the video sticker album, the so called “invite friends”.

FIG. 22. Shows the layout of an example of the page tutorial, called “how it works.”

FIG. 23. Shows a block diagram that illustrates a system (100) according to one embodiment that includes user access terminals (105).

### SUMMARY

The present disclosure provides systems and methods for a video sticker album available online, that also allows trading to be conducted through the Internet. More specifically, each image in said album will consist of at least one video sticker. From each image acquired or completed a video of the scene in question will be made available and shall be seen as many times the user/collector so desires.

The present disclosure also provides a system used to enable the use of a video sticker album developed by means of a simple software that allows users access to all information necessary for the correct use of the system. More specifically, this system provides for on-line availability of this album: an electronic site tools and operational and financial control. Even more specifically, this system allows users/collectors to acquire credits for video stickers by means of PoS systems, ePay, e-commerce and/or SMS (cell phones).

### DETAILED DESCRIPTION

In order to minimize or even overcome some of the drawbacks found in the state of the art, the present disclosure aims to develop an online video sticker album that allows images to generate a video, either by means of a single image or when completed, giving movement to the acquired scene. This album was developed by means of a complex software that is also easy to understand, which enables users to find, contact and trade with other collectors of the same product over the Internet. Embodiments of the system are available and marketed, through e-commerce (e.g., Internet), by means of one or more PoS systems (the same used for credit card transactions and/or debit), through ePay, and/or SMS (cell phones) in a second step, or by through use of a promotional product presented as, for example, bottle caps or can seals.

The present disclosure, in various embodiments, provides a video sticker album available online, which allows that images, when a sticker is acquired or completed by the user/collector, to generate a video, giving motion to a sticker/scene acquired. The album also includes tools for adapting the video stickers for mobile phones and/or tablet computers, for example. Such a video sticker album may also be made available in 3D, using holography, as well as any other similar devices.

An exemplary feature of systems and methods of some embodiments is the ability for users to initiate trades can be made online. In addition, in the album of some embodiments each image therein will include at least one video sticker. For each image acquired or completed, a video for the scene in question will be made available, which can be seen as many times the user/collector so desires.

Moreover, due to the intangibility of the video sticker album, it is intended to provide users/collectors a way to publicly display his completion status in succession, which can be done through interaction with a virtual character.

This album was designed to be available through a complex software, but that is also easy to understand, which allows users to access all information necessary for the proper use of the system, which includes: selecting album (s); registering; obtaining purchase code through the PoS system (“Post of Sale”—a system used by credit providers, e.g. Redecard and Cielo), ePay (platform of processing and capture of electronic transaction payment and prepayment) e-commerce (credit or debit card) and/or SMS (cell phones); acquisition of video-stickers; trading between collectors; trading between the collector and the system administration; contact via chat with other collectors; administration by the collector of the contents thereof; access to market quotations through information generated and provided by the system itself; access to statistical information generated by and provided by the system itself; participation in promotions; contests; prize codes video images; creating a customized group of interactive friends in communication through chat interaction with audio and video interaction with information in text and/or a virtual character (virtual puppet or characters adapted to the proposed theme), which aims to signal through special clothing and accessories, the completion percentage of the respective video album, all of this being done when the user/collector sends the desired information or paste the code line of the background of these characters in their social networks, thereby demonstrating its percentage of successful completion of the electronic album; participate in exclusive games (“video games”); generation of important market information concerning the behavior of sales offices and public support for the product and/or a promotion; the number of people who carry out the purchase of advertised product for point of sale and/or commercial property; the exact number of people who bought “x” products at “y” establishments; and any promotional activities related to operations enabled by the platform. Once companies have access to this information, they can enhance the use of “budget” of marketing media and any effort to support its associated trading. The system also provides for the delivery of online video sticker album of the present invention: an electronic site, multiple servers; operational tools and financial control; a “viral marketing” tool, such as the description hereinbelow:
(a) user registration
(b) terms and conditions of appropriate use
(c) tutorial video
(d) access page through login and password
(e) video-cover (page navigation system)
(f) purchase page of the album
(g) activation page of the album
(h) purchase page for video stickers (pictures)
(i) acquiring page for video-stickers (pictures)
(j) usage page (introduction) of the video stickers (pictures)
(k) trading page that enables the trading of video stickers to occur online or offline or that are rendered possible between users through the chat communication system
(l) internal quotations page
(m) the administration page of information relevant to the product, as follows:
   my class
   registration of spare/repeated stickers of the video sticker album (pictures)
   registration of desired stickers for the video sticker album (pictures)
   number of credits available
   control of selected video stickers (pictures)
(n) VIP page for communication and trading between collectors (closed group)
(o) knowledge quiz on the album's theme
(p) VIP area for advertisers/sponsors and/or employees
(q) shop
   Each page of the system is divided into a different numbers of fields wherein, through “mouse” clicks, the particular actions in the course of the platform are executed or displayed.

Developed with advanced technology, the system allows full control of information, operations, and of the system itself; administrative, technical, economic, financial and statistical data reports. All of this eases monitoring of possible internal and external audits and provides safety to users/collectors. The video sticker album of the present invention can be upgraded remotely by means of a specific tool available only to the administrator of the system, wherein it is displayed: a text editor—which allows the editing of all indexes corresponding to the operations; and a live preview—which allows the observation of any changes made on the website, as well as the inclusion of advertising and/or announcements at the end of each video or still sticker separate pages.

The video sticker album allows the user to print a certificate that enables one to prove the percentage thereof it has already completed. This certificate can be purchased for each 10% completed. For example, the first certificate may be issued when you have 10% of the video-stickers completed, the second when you have 20%, the third 30%, and so on, following this proportion until it is completed at 100%.

In the video sticker album described herein all visitors have free access to at least three pages of the album, namely: access to registration, cover and tutorial demo. The other pages are accessible only to users/collectors duly registered.

Hereinbelow, it is described both the mechanics of acquisition of the video stickers at points of sale (POS) as the mechanics of execution.

1. Mechanics for the Acquisition of Video-Stickers at Point of Sale

The user/collector who seeks a point of sale and purchases any item that comes with a code linked to the promotion, may, when making a purchase on any machine operating transactions with credit cards/debit cards, add cash a sum of USD (or any other currency of the country where the purchase is being made), which will be exchanged for an “x” number of codes (pin codes), which will be printed by this machine. Then, the user/collector: (a) enters the code on the Company's (“Cromo Up” or other) website linked to said promotion, (b) enter the code (PIN code) in the “get stickers” area, and (c) has access to said video-stickers. With this system, aspects of the disclosure are aimed at solving one of the problems encountered in the prior art, i.e., to enable the purchase of the code (PIN codes) by users/collectors who have neither credit card or a bank account.

Besides the purchase of video stickers in retail outlets across the country, the user/collector may also acquire said codes (pin codes) from the PoS system (“Post of Sale”) used by credit providers, e.g. Cielo and Redecard, e-commerce (credit or debit), ePay and/or SMS (cell phones).

2. Mechanical System Operation

The system by which a video sticker album of exemplary embodiments of the present disclosure is provided on the web has the following pages: (i) web pages accessible to all visitors, such as: registration, cover and tutorial demo. Therein, one can access the registry, see the options of available albums for purchase, purchase the product, access cover and a video tutorial demonstration in order to clarify the understanding of the product, and (ii) web pages accessible to users/collectors properly registered. This allows users/collectors access to all system functions.

In addition, the system displays: (a) one party controlling the content of the video sticker album. This area of the system is restricted to the management team that is responsible for all updates to the platform of any information, promotion, content, etc. (b) one party controlling the operations of the video sticker album, which is restricted to the management team that is responsible for generating emission trading and technical reports, statistical, economic, financial and administrative use and/or audit and (c) details of the function, per screen. The details of the following screens is described below:

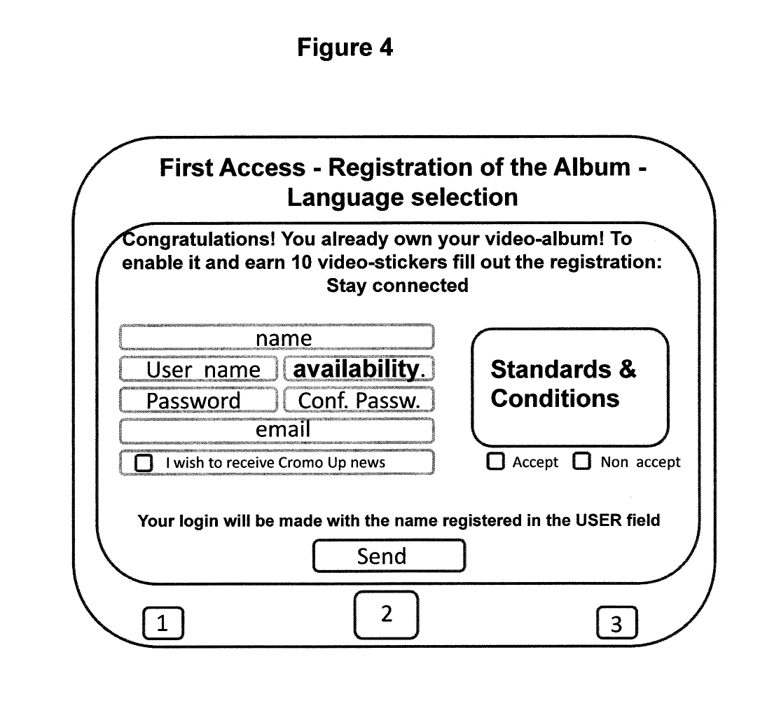

Registration (FIG. 4)

Shows one possible layout of the registration page with a choice selection of languages. On this screen the user/collector, selects the language within the options provided, choose to remain connected or not, fill in relevant data (name, e-mail, password registration, password confirmation, date of birth, terms and conditions for use of the system), and has access to the demo with a tutorial presentation of the video cover. Hereinbelow there is a description of the available fields:
1. Language Selection
2. Stay connected
3. Name
4. Login (user)
5. Check availability
6. Password
7. Password confirmation
8. E-mail
9. Date of birth
10. Terms and conditions
11. Accept terms and conditions
12. I do not agree
13. Send
14. Video Presentation

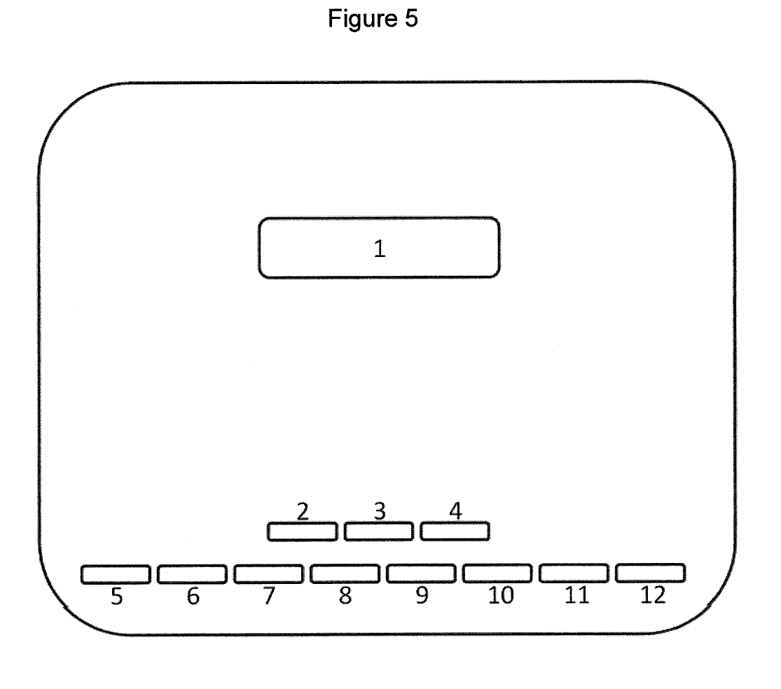

“Front Page” (FIG. 5)

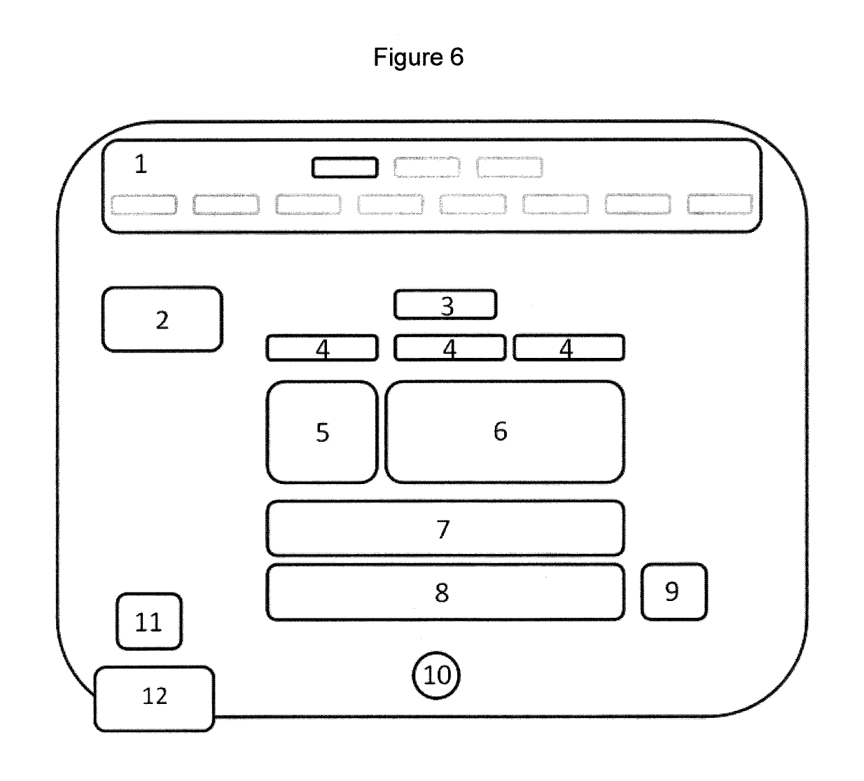

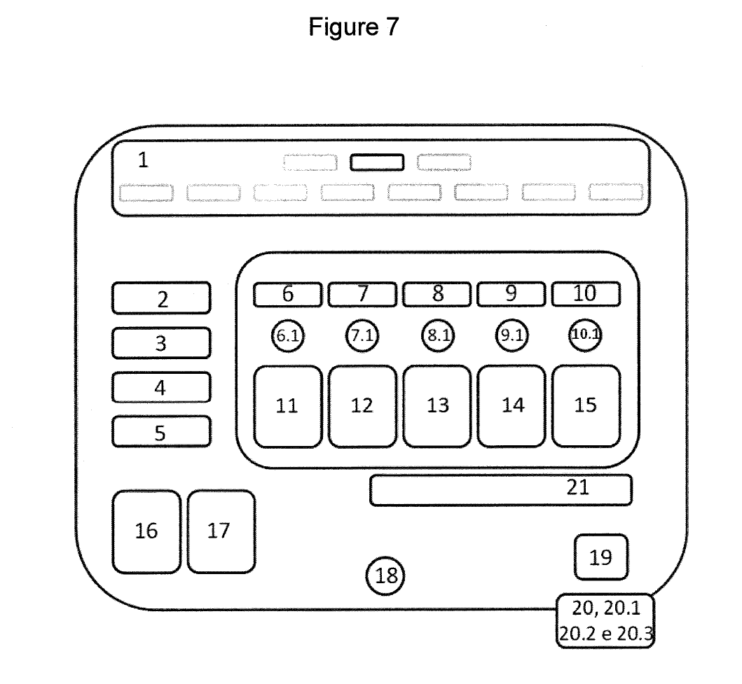

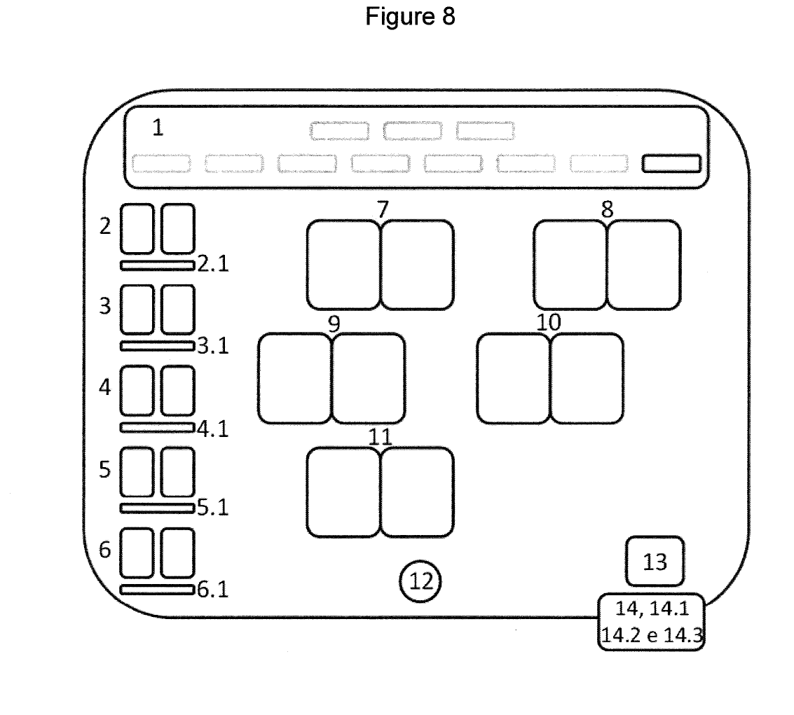

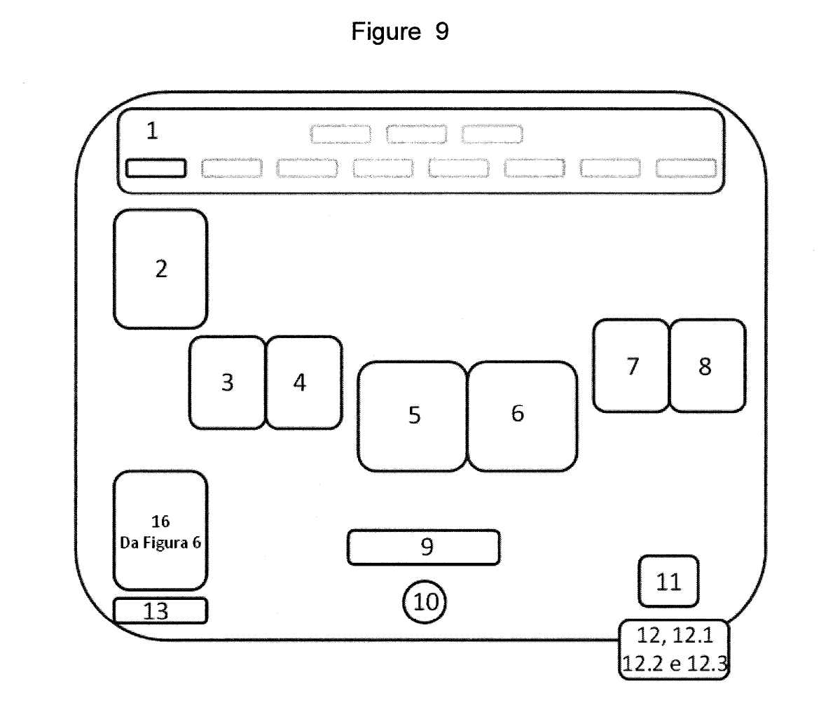

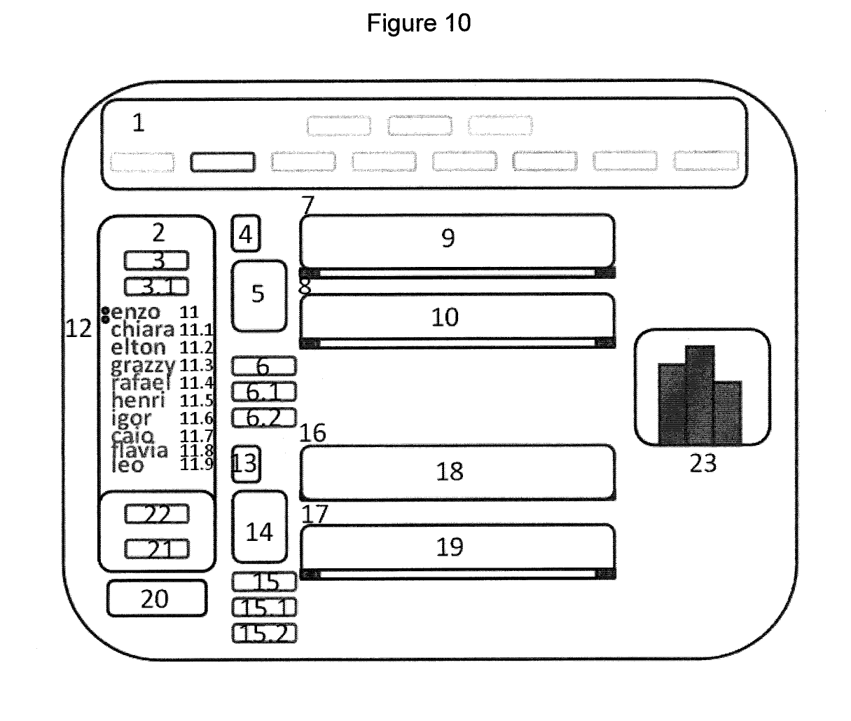

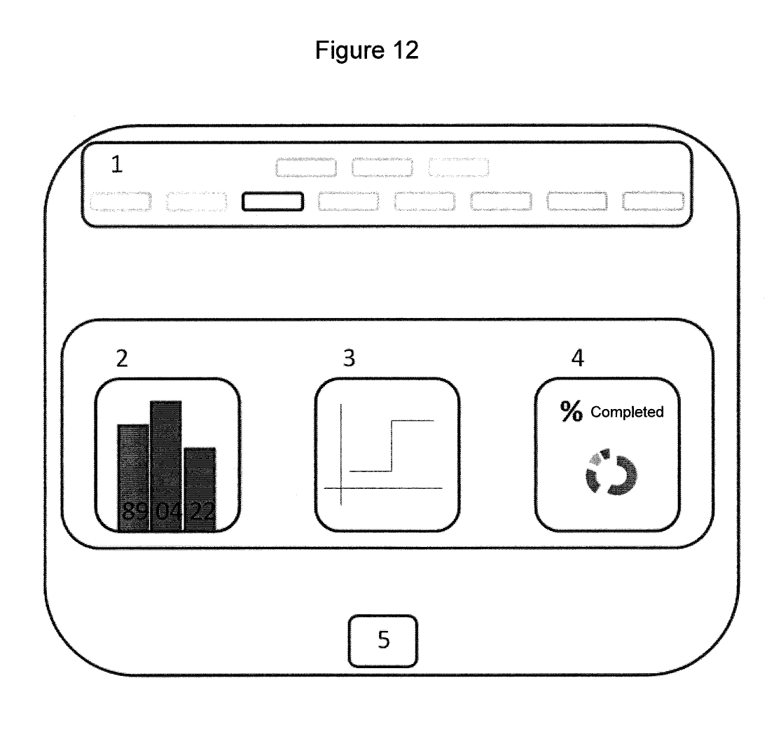

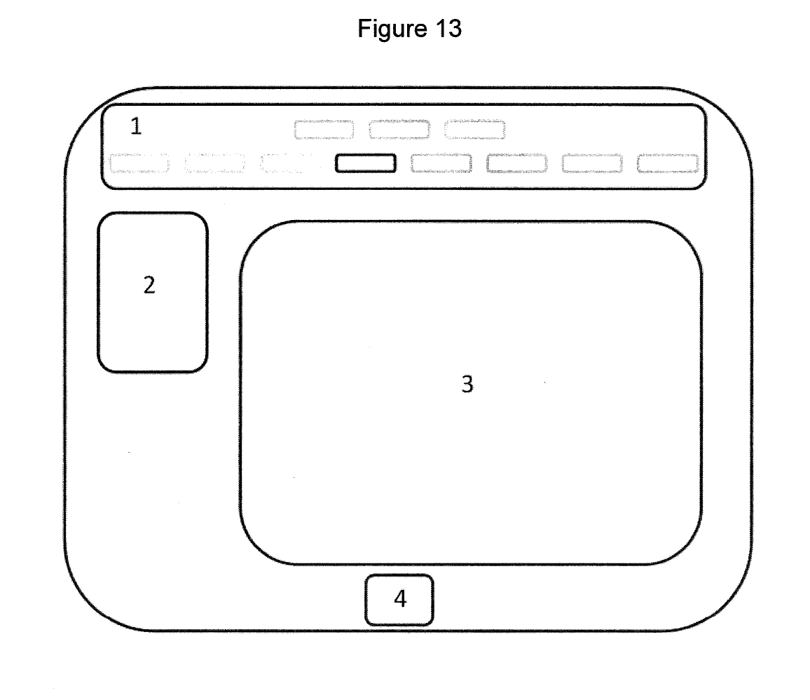

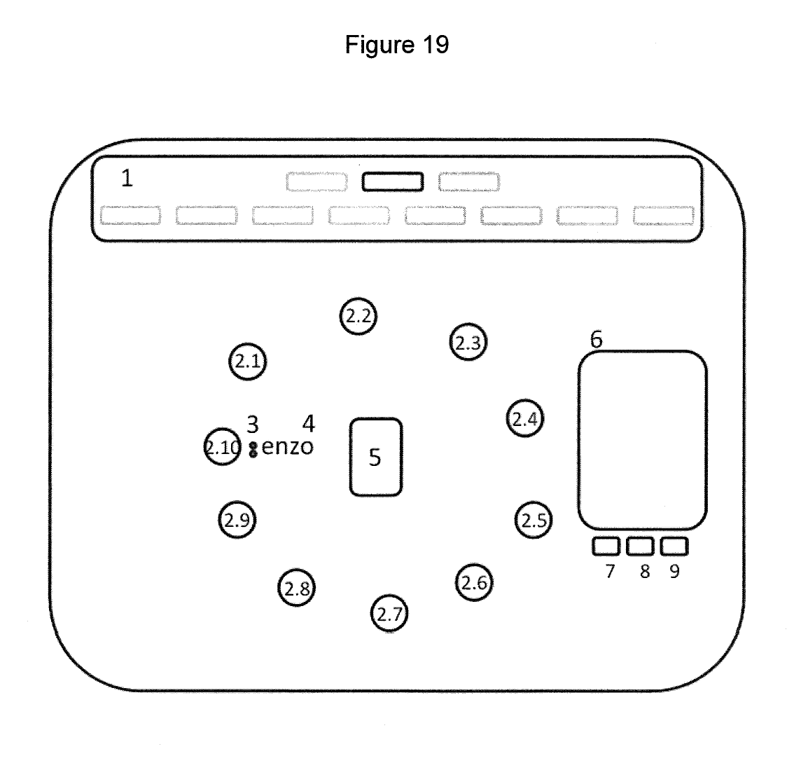

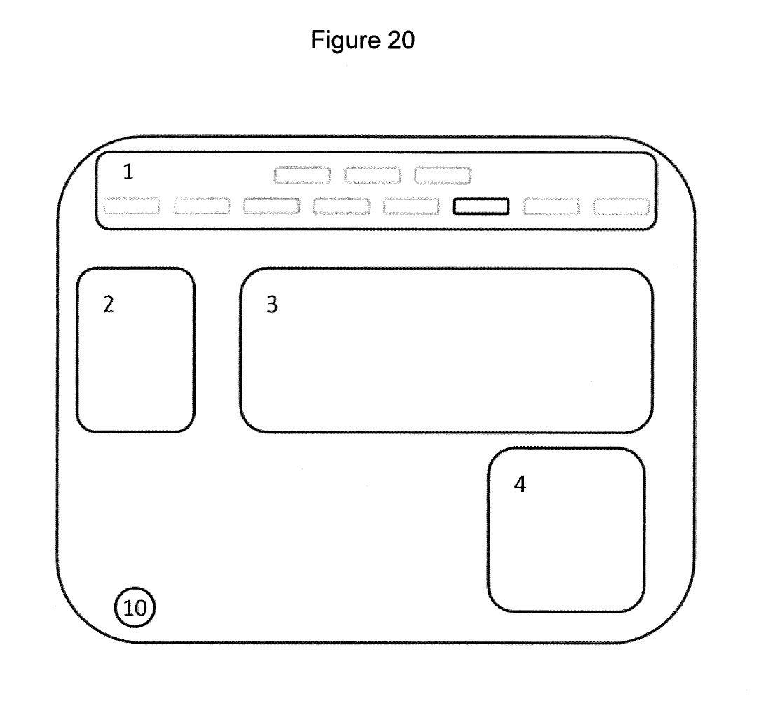

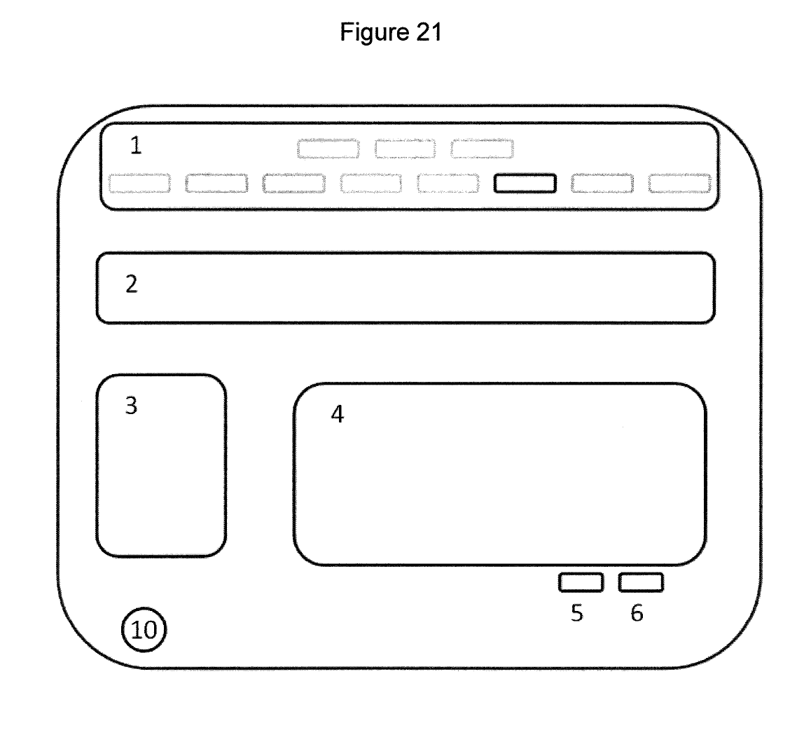

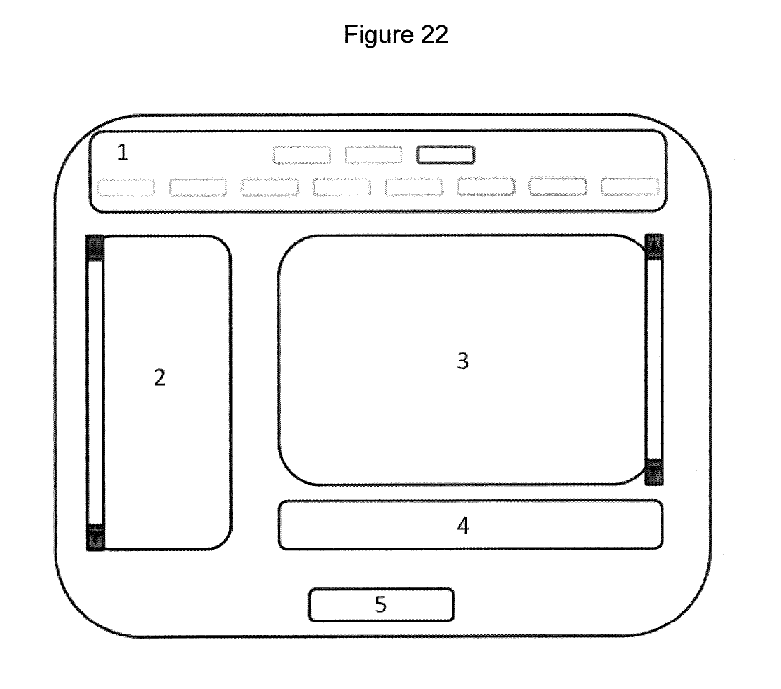

On this page the user/collector has access to the main navigation of the video sticker album and shows one possible option for the video cover of the album with navigation buttons and access buttons to the following functions related to the “buttons” below:

| | | |
|---|---|---|
| 1. | Video title-album | No picture related |
| 2. | Buying | FIG. 6 |
| 3. | Download video stickers | FIG. 7 |
| 4. | Download extra video stickers | FIG. 8 |
| 5. | My album | FIG. 9 |
| 6. | Trading | FIG. 10 |
| 7. | Quotation | FIG. 12 |
| 8. | My Account | FIG. 13 |
| 9. | VIP club | FIG. 19 |
| 10. | Contacts | FIG. 20 |
| 11. | Invite friends | FIG. 21 |
| 12. | How to use | FIG. 22 |

Purchase (FIG. 6)

On this page the user/collector has access to the values practiced and can make the purchase through ePay or e-commerce, using credit cards or debit cards, or even use payment means offered by the company, namely: online transfer or bank transfer. One can also navigates to all other sessions. On this page the user/collector must click the “mouse” in its purchase option (video album, video sticker or both). Regardless the choice, the system enables the possible forms of payment (credit card, debit, PoS, SMS, or via ePay) and in this case, the page will guide the user on how to make a purchase in retail outlets. Upon choosing a credit card or debit card, and having been selected the option to “video sticker” before, after clicking on the choice of method of payment, the system enables the “combos” that are available. As to the “combos”, the system has the purchase options of 5, 10, 20, 30, 40, 50 packages and still allows the buyer (user/collector) to fill in the desired amount. Hence, after clicking or filling the desired amount, the platform enables a control system for delivery of the purchased packages. This system allows the buyer (user/collector) to select how many packages one wishes to receive per day.

For example: A buyer (user/collector) acquires 30 packages. He can decide whether to get one, two or more packages per day. The user/collector has access to available credit at any time in the “MY ACCOUNT”.

After selecting the amount to be released per day, the system shows the summary of the order, informing to the user what was purchased, and the total amount of the purchase. Then, the system enables the fields to be filled in with the data of the holder (buyer/user/collector). This in agreement, one must click on the “Confirm Purchase”. After confirmation, the buyer (user/collector) immediately receives said credits, which can be viewed in the “MY ACCOUNT” or go directly to the section “DOWNLOAD sticker” and enjoy the product.

The user/collector may, at any time, invite a friend to be part of “the group of collectors friends.” Clicking on this option, the system enables a message box to type the name and email address of your friend/guest and send said invitation.

The user/collector may also access the navigation menu to the whole album and a video sticker tutorial specific session that shows in a step-by-step basis the process described.

Hereinbelow, there is a description of an option of the available fields:
1. Menu navigation of the video sticker album
2. Information of practical value
3. “Buy” options
4. Payment options
5. “Combos” options
6. Options to control the amount of stickers released per day
7. Summary of purchase
8. Registration of the information holder's credit/debit
9. Confirmation of purchase
10. Specific tutorial session
11. Invite a friend
   1. Field for typing the name of the guest
   2. Field for typing the Guest Email
   3. SEND Message button
12. Message Box

“Download” of Stickers (FIG. 7)

On this example page the user/collector can do the “download” of a code (PIN codes) acquired (i.e., purchased or acquired through the bonus system or through promotions). To purchase the video-stickers, the user/collector should select the category of codes as signaled in the fields 2, 3, 4 and 5 of the respective figure. Then, the system enables the fields wherein the codes (pin codes) should be entered in fields 6, 7, 8, 9 and 10 of the figure. Once entered and recognized, the system enables the button “OK” (6.1 to 10.1 of the figure), which must be clicked to trigger the “download” command. Then, the system provides the video and automatically separates stickers, which may be accessed on the “my album” section. The video stickers bring the page number and the field that must be applied.

The user/collector may, at any time, invite a friend to be part of “their group of collectors friends.” Clicking on this option, the system enables a message box to type the name and email address of your friend/guest and to send the invitation.

The user/collector may also access the navigation menu to the whole album and a video tutorial stickers specific session that shows the step-by-step of the process described.

Hereinbelow, there is a description of an example of the available fields:
1. Navigation Menu
2. Purchased
3. Bonus
4. Promotional
5. Trading
6. Typing field for the “pin code”
   6.1 “ok” command to “download”
7. Typing field for the “pin code”
   7.1 “ok” command to “download”
8. Typing field for the “pin code”
   8.1 “ok” command to “download”
9. Typing field for the “pin code”
   9.1 “ok” command to “download”
10. Typing field for the “pin code”
   10.1 “ok” command to “download”
11. Demonstration section of the acquired video-sticker
12. Demonstration section of the acquired video-sticker
13. Demonstration section of the acquired video-sticker
14. Demonstration section of the acquired video-sticker
15. Demonstration section of the acquired video-sticker
16. Area for a group of unreleased stickers-videos
17. Area for grouping the spare/repeated video-stickers
18. Specific tutorial session
19. Invite a friend
20. Message Box
   20.1 Field for typing the name of the guest
   20.2 Field for typing the email of the guest
   20.3 SEND message button

Extra Stickers (FIG. 8)

On this page the user/collector may acquire unofficial video stickers to main content. Here the user/collector can assemble a video sticker album custom array within the album. For this, the user/collector must choose between the video-stickers previously available and enter the “pin code” within the fields, so that the system automatically applies the video sticker at the desired/proper places.

The user/collector may, at any time, invite a friend to be part of “a group of collectors friends.” Clicking on this option, the system enables a message box to fill in the name and email address of one's friend/guest and send the invitation.

The user/collector may also access the navigation menu to the whole album and a video stickers tutorial specific session that shows the step-by-step of the process described.

Hereinbelow, there is a description of the available fields:
1. Navigation Menu
2. Area of video—sticker previously available
   1. Area for filling in the “pin-code” for an automatic “download”
3. Area of video—sticker previously available
   1. Area for filling in the “pin-code” for an automatic “download”
4. Area of video—sticker previously available
   1. Area for filling in the “pin-code” for an automatic “download”
5. Area of video—sticker previously available
   1. Area for filling in the “pin-code” for an automatic “download”
6. Area of video—sticker previously available
   1. Area for filling in the “pin-code” for an automatic “download”
7. Area for extra video-sticker stamping
8. Area for extra video-sticker stamping
9. Area for extra video-sticker stamping
10. Area for extra video-sticker stamping
11. Area for extra video-sticker stamping
12. Specific tutorial session
13. Invite a friend
14. Message Box
   14.1 Area for filling in the name of the guest
   14.2 Area for filling in the email of the guest
   14.3. SEND message button

My Album (FIG. 9)

On this page it is possible that the user/collector see the layout of the page content selection and to access the video sticker album. Therein, the user/collector stickers applies the video and actually acquires the collection. Moreover, it is possible that in this page the user sees the area of each sticking place of the v.s the quotation graphic in real time, and may also request the trading of any v.s by means of the respective fields.

To stick video stickers, the user/collector should identify the number of video-sticker and the page number where it should be stamped. Then, the user/collector must go to the page indicated and may use the sub menu contents or change the menu page, click on the video sticker and drag with the left button of the “mouse” to the respective field. To stick the video sticker, one should simply release the button clicked with the “mouse” so that the sticker is stamped. By completing the double-video stickers (Ex: 3 and 4) required to form a scene acquired, then the system enables a command button called “play”, which when activated causes the video to turns into a video sticker scene, showing the selection. This procedure can be repeated as many times as selected by the collector, and said video can be created simultaneously with other stickers, not necessarily needing to be a link between them.

The user/collector may, at any time, invite a friend to be part of “their group of collectors friends.” Clicking on this option, the system enables a message box to fill in the name and email address of one's friend/guest and send the invitation.

The user/collector may also access the navigation menu to the whole album and a video stickers tutorial specific session that shows the step-by-step of the process described.

Hereinbelow, there is a description of an example of the available fields:
1. Navigation Menu
2. Sub Menu contents
3. Stamping area for video-sticker
4. Stamping area for video-sticker
5. Stamping area for video-sticker
6. Stamping area for video-sticker
7. Stamping area for video-sticker
8. Stamping area for video-sticker
9. Change page menu
10. Specific tutorial session
11. Invite a friend
12. Message Box
   12.1 Field for typing the name of the guest
   12.2 Field for typing the email of the guest
   12.3 SEND message button
13. Identification area of number of the video-sticker and its classification as a spare/repeated or new one.
16. Area for a group of unreleased video stickers.
   Regarding this page, it is important to note that it may contain several variations based on advanced graphics software (e.g. 3D Studio Max), with different developments, and continued with the navigation system and for setting the video stickers.

Trading (FIG. 10)

The trading of video stickers can be made either online or offline, directly from the preview and pasting page, by clicking on the field of the desired v.s. Once the user/collector accesses this page, the system automatically loads the information identified therein, such as (1) navigation menu Video-album, (2) name, (3) search field, (3.1) “send” button and start the search for desired video sticker, (4) photo of the owner, (5) “upload” area of the owner, in which will appear the image of the video sticker, (6) “upload” button of the owner, defined as the “command button” that, when clicked, starts the process of “uploading” the said video sticker; (6.1) button for switching confirmation of the owner; (6.2) cancellation of trade button for the owner, (7 and 8) titles of the sessions, and the list of the desired video stickers (v.$) spare (9) and/or repeated (10) video stickers owned video stickers.

For the trading to be concluded, it is necessary that the user/collector type the desired number of v.s and click the button (3.1) to “submit search”. Then, the system identifies randomly ten other collectors who have the desired v.s, crossing information and detecting which of the other collectors who have in their v.s relationships some of the desired v.s that the owner has in its database of repeated/spare vs. By randomly identifying other collectors that have the desired v.s, the system loads the area of identification, providing, for example, (11 to 11.9) within ten names of the characteristics listed above.

The platform features an innovative system of signaling status “on-line/off-line” (12), which eases the operation of this page. The “online” trading system allows the user/collector to identify other connected users at the same time, regardless of time zone, as well as easing the communication between them in real time.

Once one identifies the collector in question, the owner (user/collector) and any collector chooses randomly invited ones to make a trade by double clicking the left button of the “mouse” over the chosen name (11 to 11.9). by doing so, the system enables the fields of (13) picture of the selected collector, (14) “upload” area of the guest, (15) “upload” button of the guest, (15.1) button for switching confirmation of the guest, (15.2) cancel button to return for guests, (16 and 17) titles of the sessions, the viewing area of the desired (19) v.s and repeated/spare (18) v.s of the guest. To assure that the trading occurs, it is necessary that the owner of the v.s clicks the number of one's interest within the display area of the guest's repeated/spare v.s (18). Then, the system loads its v.s in the “upload” of the guest (14). If the same procedure is performed by the guest, by clicking on the repeated viewing of the v.s (9) of the owner (user/collector), the system loads the v.s chosen by the guest in the “upload” (5) of the owner. After that, both the involved parties must click on the buttons for switching confirmation (6 and 15), so that the system identifies the intent of both parties, and makes the trading of the available codes for the desired v.s in the “Download video stickers” area.

Another option available on this page to the user/collector is that one can choose between a “multi trade” option, performing the trade of a v.s for two or more (limited to 10 units) v.s and vice versa, and for doing so one must click on the button (20) “invite multi trade.” Thus, the system enables and disables some other fields, i.e. enables a second area of “upload” from the guest, the confirmation trade button, viewing area of “upload” of the ten v.s allowed in this operation, displays an area for the Guest name, displays spaces for multi trade on the “upload” buttons and the confirmation of trading display area for prices. If the guest decides to do the same operation (multi trade) with the same user/collector, after finishing the first negotiation, one should “invite specific user,” as a login by entering the official identification of the user, and then click on the button “send invitation”. That being done, there is a need to repeat the entire operation described above.

In this window, the chat area can be used at any time by the user/owner and the user/guest, since the two are logged in the system at the same time. To establish contact, one of the two users must click in the text entry and hit the “send” button.

The user/collector may also access the navigation menu to the whole album and a video sticker tutorial specific session that shows the step-by-step of the process described. At any time, the user/collector may invite a friend (21), trigger the trading of Premium and Gold stickers with the system administration (22) and obtain information regarding quotations via the stock chart (23).

The trading system of the video sticker album of the present invention, when using a tablet, works as follows: two collectors A and B can match their tablets so that video-stickers can be traded between them. Thus, while the collector gets a v.s. from the collector B this, in turn, takes another video sticker from collector A. The trading occurs as if the video were playing cards, stickers gliding on top of a table (tablet to tablet). In order to prevent the collector B, for example, to act in bad faith and hold the v.s of A before giving him another v.s in exchange, by turning off snapshot of the tablet, the system blocks such unfair action so as to reconnect the tablet of B, the collector v.s being returned to A.

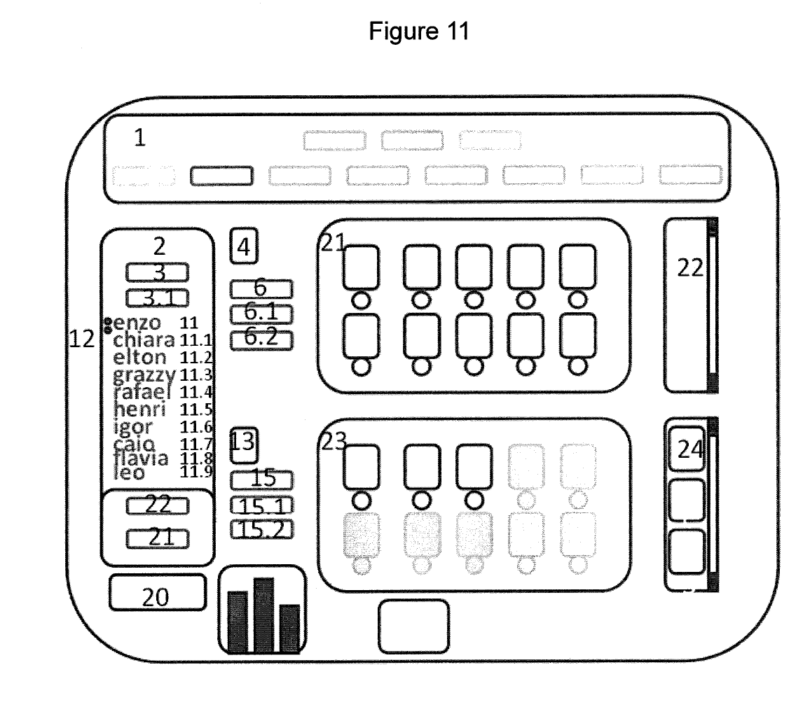

Multi Trade (FIG. 11)

In this session, the collector can perform the same actions listed in FIG. 10, however with the possibility of exchanging 1×n or n×1 video stickers. In this case, the system disables, for example, the fields 5, 7, 8, 9, 10, 14, 16, 17, 18 and 19 of FIG. 10 and enables, for example, the fields of numbers 21, 22, 23 and 24.

Quotations (FIG. 12)

On this page the user/collector of information can quote market valuation of the Company (“Cromo Up” or other) video stickers of the three most desired by collectors as well as statistical information related to video stickers.

This system provides an information page similar to “stock exchange”, in language suited to the understanding of a child with the intention of stimulating the thinking of the basics of economic management. On said screen, there is a video illustrating the theme of the product in question. When one accesses it the user/collector can be guided on the market value of a particular Company (“Cromo Up” or other) video sticker, to negotiate a trade for better utilization, which can be done in the “change”.

To access this page, the collector must click on the quick access button “change” or click the quick access “multi trade.” The price can be seen in “graphic demonstration”, for example, “the three most wanted video stickers” (2), a result of information supplied in the “My Account—desired video stickers.” Thus, the user/collector can track the number of people who joined the product through the “graphic accession collectors” (3) and still know the “statement of percentage completed” (4).

The user/collector may also access the navigation menu to the whole album and a video stickers tutorial specific session that shows the step-by-step of the process described.

The user/collector may, at any time, invite a friend to be part of “their group of collectors friends.” Clicking on this option, the system enables a message box to fill in the name and email address of said friend/guest and sends the invitation.

My Account (FIG. 13)

On this page, the user/collector is able to navigate around the video album through the menu navigation (1), can obtain information generated by the system administration, as well as supply the system with other information that will be exploited in the favor thereof in other pages. For the user/collector to access to the alternatives offered in this page, one must click one of the options in the sub-menu (2): my class, repeated/spare stickers, desired stickers, my credits and special premium & gold stickers. One can still have access to a specific tutorial session (4). The information (sub-screens) for any one of the above, appears in field 3 “viewing options sub-menu” and are described hereinbelow.

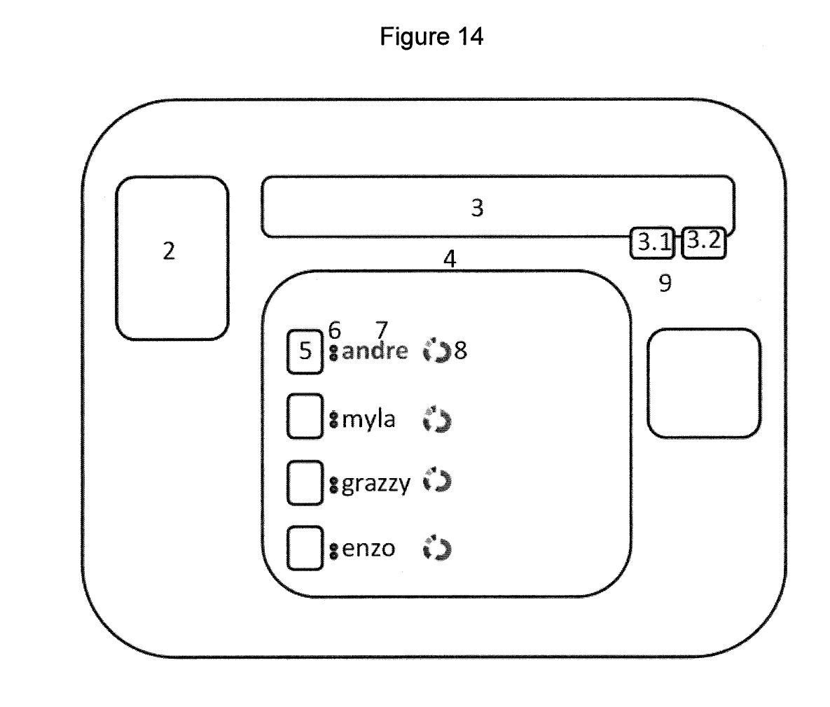

My Class Submenu (FIG. 14)

On this page, the system enables the user's/collector's picture (2) and allows one to invite friends. By clicking on this option, there is enabled a message box (3) to the user/collector fill in the name and e-mail the guest by sending (3.1) or canceling (3.2) the invitation, and if one sends it, the friend guest-appear on the desktop of friends (4) as their guests with information and photo (5). One can also “edit friends” (9) and view the list of registered friends—identifying whether they are connected by means of the “status signaling” (6), viewing not only their data but also the statement of the percentage completed for each registered friend (7 and 8).

In order to change the sub menu, the collector must click on another sub-menu option (field 2 in FIG. 13) or choose another page in the navigation menu.

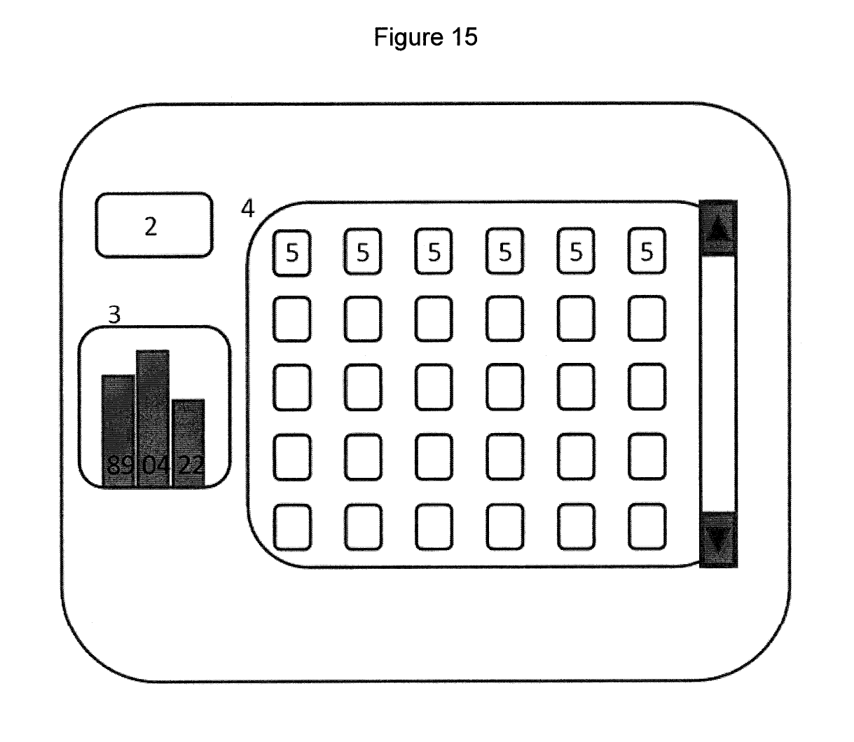

Sub menu for repeated/spare stickers (FIG. 15)

On this page, one can view the repeated stickers by images and/or the quantity thereof. This information is generated automatically when the collector downloads the video-stickers (v.s) (Field 3 of FIG. 5) and classifies them as a repeated/spare v.s. As instructed in the “video-stickers download”, the collector must drag the v.s to the given field (field 17 of FIG. 7) when, once therein stamped, the system identifies the code and automatically updates the information and images (5) for this sub section. The collector can also view images at the “viewing area for repeated video-stickers” (4). To ease navigation, the user/collector should use the “scroll bar” so as to view the field “statement of the amount of repeated video stickers” (2) and check the prices on the chart preview quotation (3). So as to change the sub menu, the user/collector must click on another sub-menu option (2) of FIG. 13 or opt for another section in the navigation menu.

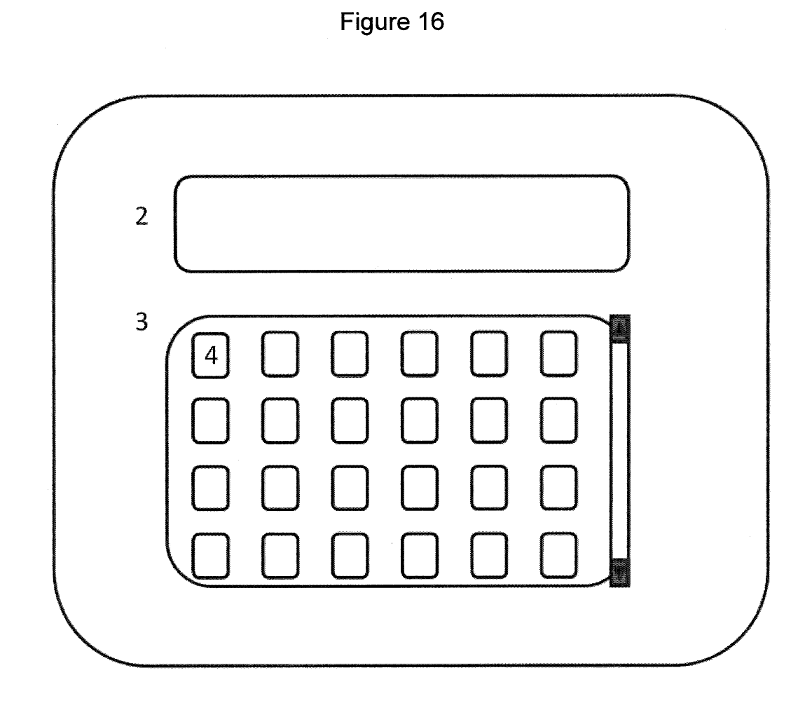

Sub Menu Desired Stickers (FIG. 16)

On this page, the user/collector may register the desired video stickers. To this end, one should select the sub-menu of topics of the content (2) at one of the options available. The v.s listings can be viewed on the “demonstration area of desired v.s” (3) viewing images (4). To ease navigation, the user/collector should use the “scroll bar”. In order to change the sub menu, the user/collector must click on another option from the sub menu or opt for another session in the navigation menu.

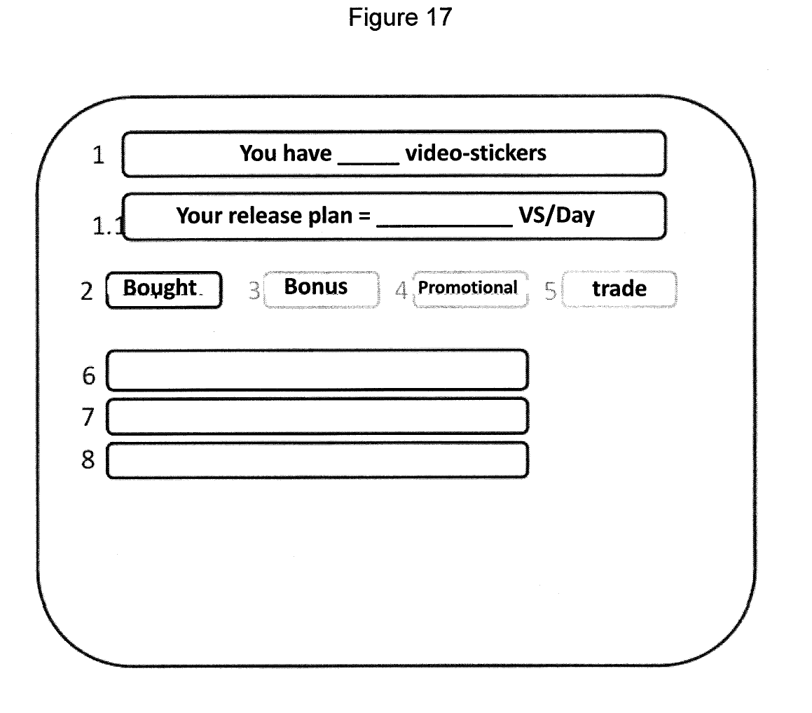

My Credits Sub Menu (FIG. 17)

On this page, the user/collector may: identify the number of v.s available to stamp in the video sticker album as per the field “stickers that you have” (1); knowing with the “release plan” (1.1) what was recorded in the last purchase, to identify how many were the “video released stickers” by type of acquisition, i.e., if they were “bought” (2), if they were acquired by “bonus” (3), if they were “promotional” (4) or acquired by “trading” (5); see how many “video stickers yet to be released” (6), check the amount of “v.s acquired and used” (7) and the amount of “v.s acquired and liberated” (8) to stamp in said album. If the user/collector has released credit to be used, one should click on “download video sticker”, in case there is interest in using it. In order to change the sub menu, the user/collector must click on another option from the sub menu or opt for another session in the navigation menu.

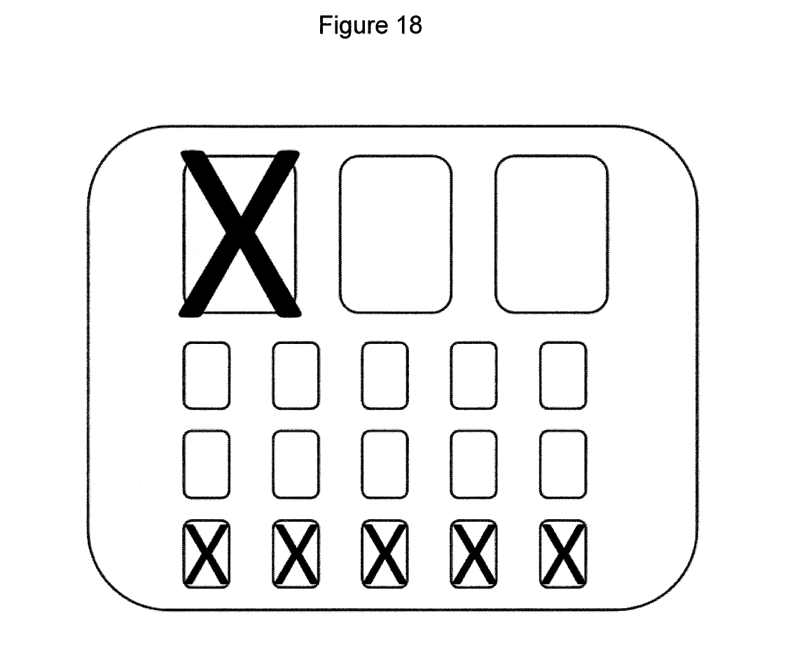

Sub Menu Special Stickers Premium & Gold (FIG. 18)

On this page, the user/collector may acquire the special video stickers, identified as PREMIUM (shown, for example, in the rows below where they appear 5×) and GOLD (shown, for example, in the top row where it appears as a 1×), randomly on any purchase. Each album accepts the use of up to three golds. A GOLD sticker can be replaced with the proper governance of the system by any video sticker, even the highest rated. Due to the difficulty of acquiring a GOLD sticker, a larger amount of PREMIUM stickers will be available. For each five (5) PREMIUM stickers, the system enables and provides 1 (one) GOLD sticker. As each album allows only three (3) GOLD stickers, the system automatically accepts only 15 (fifteen) PREMIUM stickers. If the user/collector is to acquire more than fifteen (15) PREMIUM stickers and/or 3 (three) GOLD stickers, they will be automatically posted in the submenu and may be traded on the “multi-trade” with other users/collectors or directly with the administration. Each GOLD sticker purchased will be automatically available in the “download video-sticker section. In order to change the sub menu, the user/collector must click on another option from the sub menu or opt for another session in the navigation menu.

Each album, due to the difficulty of obtaining certain stickers, will be allowed to use the PREMIUM GOLD and to make direct exchange with the administration of the system or after using the amount allowed by the system, the collector may use one or more PREMIUM GOLD stickers on the system or trading.

VIP Club (FIG. 19)

On this page the user/collector has an area of the video that illustrates the product in question, which is designed so that the user/collector may have a group of “VIP” frequent contacts.

By entering this page, the system loads the “photo of the collector” (5) and enables, for example, ten areas of recruitment (2.1 to 2.10) that enables one to invite a friend to join this selected team (“VIP”). This requires one to enter the page “My Account” in the sub menu “my class” and click on “invite friends” (as described in FIG. 14, which is specific to the company's VIP Club of the Company (“Cromo Up” or other). Then, the system enables a “message box” that, when clicked, enables another message box wherein the user/collector may enter the name and e-mail of a guest, and send him an invitation. It also enables an “chat area” (6) and displays the page layout in the VIP club of friends of the user/collector, which can also be used to access social networks through the “quick access buttons”, such as Orkut, Twitter, Facebook, etc. The collector can still access the menu navigation (1) as the whole album and a video tutorial (19) specific session that shows a step-by-step guide throughout the process described.

Contact (FIG. 20)

On this page, the user/collector may establish contact by selecting the available options in the sub-menu (2) or by automated “online” contact by the client chat system (4). If the user/collector chooses to contact the directors, he must double-click the left button of the “mouse” in one of the options enabled for the contact areas within the field number 2. Then, the system enables a “message box” (3), where one can enter a message, suggestion, criticism or request, which can then be “sent” or “cleaned” (excluded).

The user/collector may also have access to the menu navigation (1) as the whole album and a video stickers specific tutorial session (10) showing the step-by-step of the process described.

Invite Friends (FIG. 21)

On this page the user/collector can invite friends to participate in the video sticker album online. For each invitation accepted, the system credits three video stickers to the user/collector and three video stickers to the new user. Both will be credited in the “download video-stickers” section.

At any time, to invite a friend, the user/collector can click on “view contact” (2) field and enter the e-mail of a guest, or one can choose to access the sub-menu “messages waiting” (3), selecting the desired option and double clicking on that option. Then, the system loads the selected message in a “message box” (4) and, to be sent, one should just click on the “send” button (5). If one decides not to make the invitation, the user/collector should click on “clean” (6).

The user/collector may also access the navigation menu (1) as the whole album and a video stickers specific tutorial session (10) showing the step-by-step of the process described.

It should be noted that the “invite friends” figure is different from that described in FIG. 14, since herein the tool is used as viral marketing, and is specific to invite acquaintances to buy the album and video stickers and to participate in the “quiz” and/or promotion.

How it Works (FIG. 22)

On this page the user/collector has a full tutorial video for the sticker album available online. To access the information therein available, the user/collector must choose one of the options in the submenu (2) of functions and double-click over the title of the desired information. Then, the system loads all the information relevant to the area (3) of, for example, the description of the sub-items (2.1 to 2.29) that appear in Field 2 wherein the “caption” appears. This session, after the system provides the content requested by the collector, is an authorized area of interview (4) that aims to measure the degree of satisfaction and utility of the information transmitted.

The user/collector may also access the navigation menu (1) regarding the whole video sticker album, as well as a specific tutorial session (5).

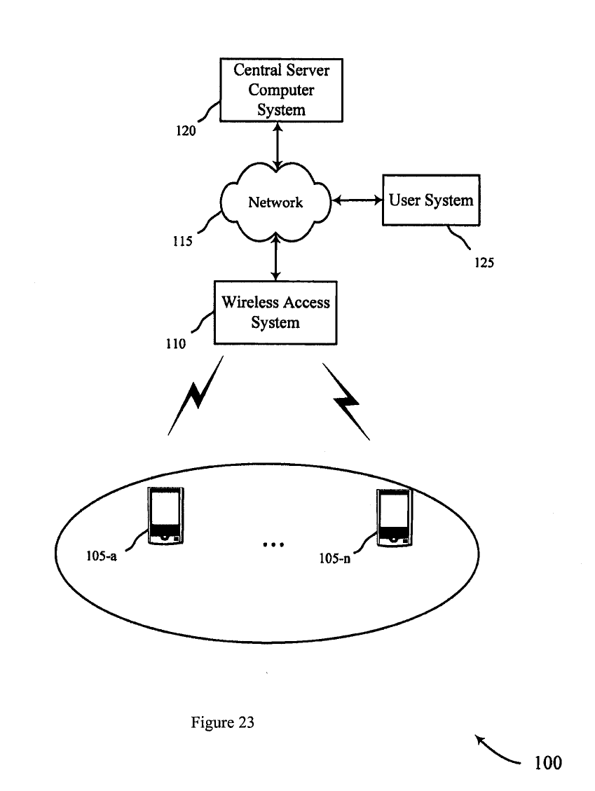

Referring now to FIG. 23, a block diagram illustrates a system 100 according to one embodiment that includes user access terminals 105. A user access terminal 105 may be one of a number of devices, such as a smartphone, a cellular phone, a VoIP phone, a personal digital assistant, a tablet computer, a laptop computer, a portable digital music player, or other mobile device that communicates voice or data, or any combination of the foregoing. A user access terminal 105 may also include a network connected computer system that includes a wired or wireless connection to a local area network, for example. It will be readily understood that a user access terminal may include any suitable device capable of operating to perform the functions for control user access to electronic applications, and the particular components illustrated in FIG. 23 are for purposes of illustration and discussion of general concepts described herein. In various embodiments, the user access terminals 105 are capable of operating according to the above-described examples.

The user access terminals 105, in the embodiment of FIG. 23, connect to a wireless access system 110 through a wireless network. Such a wireless network may include any suitable wireless network capable of transmitting data on any of a number of different wireless protocols. Such networks are well known and need not be described in further detail here. The wireless access system 110 is interconnected to a network 115 such as, for example, the Internet, which has other network attached components. A central server computer system 120 is connected to the network 115 and, in various embodiments, performs functions related to storage and retrieval of v.s., chat control, user access control, storage of PIN numbers, and the like. The central server computer system 120 may, for example, be made up one or more server computers, personal computers, workstations, web servers, or other suitable computing devices, and the individual computing device(s) for a given server may be local or remote from each other. A user system 125 is also connected to the network 115. Such a user system 125 may be another point of user access to the albums and information described above.

Those skilled in the art will understand that minor modifications related to both the video sticker album available online as well as in the system involved in the operation thereof, both described in this specification, are included in the scope of the invention.

1. Video stickers (v.s) album system available on-line, comprising:
a central server configured to allow still images, when acquired or completed by a user/collector, to generate a video that gives motion to an acquired scene, and further configured to provide on-line trading of one or more still images through an interface accessible in two or more languages.

2. The album system, according to claim 1, wherein each image of the album includes at least one video sticker (v.s).

3. The album system, according to claim 1, wherein the central server is further configured to publicly display a stage of a collection of the user/collector through: (i) the posting of texts in social networking sites or (ii) the interaction with a virtual character background whose codes can be pasted into social networking sites, to demonstrate the percentage of completion of the v.s. album.

4. The album system, according to claim 1, wherein users may access to all necessary information through an electronic site tool and operational control accessible through one or more remote terminals.

5. The album system, according to claim 4, wherein the central server is further configured to allow: (i) total control of information, operations, and the system, and (ii) reporting administrative, technical, economic, financial and statistical aspects to one or more users.

6. The album system, according to claim 4, wherein the system is configured to be remotely updated by a system administrator.

7. The album system, according to claim 1, wherein the user/collector may acquire credits through one or more of video games, an ePay system, e-commerce, SMS (mobile phones), PoS and retail outlets.

8. The album system, according to claim 4, wherein the central server is further configured to provide a first set of web pages accessible to all visitors, and a second set of web pages only accessible to registered users/collectors.

9. The album system, according to claim 4, wherein the central server is further configured to provide: (a) one party control of the content of the video sticker album; (b) a part of the operations of the parent album video stickers, which is restricted to the management team that is responsible for generating trading emission and technical, statistical, economic, financial and administrative use and/or audit reports; and (c) list of contents, per screen.

10. The album system, according to claim 1, wherein the ventral server is accessible through one or more remote devices, including mobile phones, and tablets, and the one or more video stickers are available in 3D.

11. The album system, according to claim 1, wherein users/collectors of video-sticker album access all necessary information using a virtual album of electronic and website tools.

12. The album system according to claim 11, wherein the central server is further configured to provide an administrator of the video-sticker album with (i) total control of information and operations and (ii) permission to issue administrative, technical, economic, financial and statistical reports about said collection.

13. The album system according to claim 11, wherein the central server is further configured to allow the user/collector of the video sticker album to have access to public information from other collectors.

14. The album system according to claim 11, wherein the central server is further configured to allow the video sticker album to be updated remotely by the system administrator.

15. The album system according to claim 11, wherein the central server is further configures to provide (a) one party control of the content of the video sticker album; (b) one party control of the operations of the video sticker album, restricted to a management team that is responsible for generating trading emission and technical, statistical, economic and financial administrative use reports; and/or audit and (c) listing of the contents, per screen.
